(19) United States
(12) Patent Application Publication
(10) Pub. No.: US 2024/0314612 A1
(43) Pub. Date: Sep. 19, 2024

(54) METHOD AND APPARATUS FOR REPORTING MEASUREMENT IN WIRELESS COMMUNICATION SYSTEM

(71) Applicant: ELECTRONICS AND TELECOMMUNICATIONS RESEARCH INSTITUTE, Daejeon (KR)

(72) Inventors: Hyun Seo PARK, Daejeon (KR); Yong Jin KWON, Daejeon (KR); Yun Joo KIM, Daejeon (KR); Han Jun PARK, Daejeon (KR); Jung Bo SON, Daejeon (KR); An Seok LEE, Daejeon (KR); Yu Ro LEE, Daejeon (KR); Sung Cheol CHANG, Daejeon (KR); Heesoo LEE, Daejeon (KR)

(73) Assignee: ELECTRONICS AND TELECOMMUNICATIONS RESEARCH INSTITUTE, Daejeon (KR)

(21) Appl. No.: 18/599,151

(22) Filed: Mar. 7, 2024

(30) Foreign Application Priority Data
Mar. 7, 2023 (KR) 10-2023-0030131

(51) Int. Cl. H04W 24/10; H04W 36/00

(52) U.S. Cl. CPC H04W 24/10; H04W 36/0085

(57) ABSTRACT

A method of a terminal may comprise: receiving, from a serving cell, a first message including measurement report configuration information; in response to transmission of a measurement report message being triggered based on the first message, generating a measurement report message; and in response to a measurement report message transmission condition configured by the first message being satisfied, transmitting the measurement report message to the serving cell.

### CROSS-REFERENCE TO RELATED APPLICATIONS

This application claims priority to Korean Patent Application No. 10-2023-0030131, filed on Mar. 7, 2023, with the Korean Intellectual Property Office (KIPO), the entire contents of which are hereby incorporated by reference.

### BACKGROUND

### 1. Technical Field

The present disclosure relates to a wireless communication technique, and more particularly, to a measurement reporting technique in a wireless communication system.

### 2. Related Art

In New Radio (NR) and Long Term Evolution (LTE) systems, mobile-assisted and network-controlled handover can be performed for managing terminal mobility in a connected state. The terminal measures signal strengths of a serving cell and neighbor cells, and when a specific event occurs based on these measurements, it transmits a measurement report (MR) message to a source base station. Typically, an A3 event occurs when a signal strength of a specific neighbor cell is better than that of the serving cell by a handover (HO) margin (HOM) or more for a trigger time (i.e. time-to-trigger, TTT), which may be configured as a measurement reporting event.

Upon receiving the MR message from the terminal triggered by the measurement reporting event, the source base station determines a target cell to which the terminal is to be handed over and transmits a HO request message to a target base station to prepare for the handover. The target base station then performs admission control for the terminal handover and transmits a HO request acknowledgment (ACK) message to the source base station, indicating acceptance of the handover.

The source base station, upon receiving the HO request ACK message, relays a HO command (CMD) message received from the target base station to the terminal. The terminal ceases data transmission to the terminal and forwards the data to the target base station. Subsequently, the terminal, upon receiving the HO CMD message, promptly disconnects from the source cell, acquires downlink (DL) synchronization with the target cell, and initiates access to the target cell by executing a random access (RA) procedure. If the RA procedure is successful, the terminal transmits a HO complete message to the target base station, indicating the successful completion of the handover procedure.

As mobile communication systems evolve, more base stations are being installed at higher densities to enhance the perceived transmission speed for users. Consequently, the number of neighbor cells with signal strengths surpassing that of the serving cell is increasing within a handover region of the terminal. Therefore, measurement reporting events may occur in a large number of cells within a short period of time.

In this scenario, a first neighbor cell where an event initially occurs may not be the optimal neighbor cell, and a subsequent best neighbor cell could generate the same event shortly afterward. With the installation of more base stations, this situation may occur more frequently. Consequently, when the base station selects the first neighbor cell as a target cell based on the terminal's measurement report, the terminal might undergo a handover to the first neighbor cell and then another to the superior second neighbor cell shortly after, resulting in doubled handover interruption time due to two handovers. Alternatively, if the base station waits until the same event occurs in the second neighbor cell before designating it as a target cell, the terminal would need to sustain communication with the serving cell with a poor link state until the handover to the second neighbor cell. In such a scenario, the terminal might encounter a radio link failure (RLF) and endure a longer interruption period, leading to a significant decline in communication quality within the handover region.

Furthermore, the terminal frequently transmitting measurement reports within short intervals may lead to issues such as unnecessary utilization of radio resources and delays in the transmission of other data.

### SUMMARY

The present disclosure for resolving the above-described problems is directed to providing a measurement reporting method and apparatus, which prevents from unnecessary additional handovers from occurring.

According to a first exemplary embodiment of the present disclosure, a method of a terminal may comprise: receiving, from a serving cell, a first message including measurement report configuration information; in response to transmission of a measurement report message being triggered based on the first message, generating a measurement report message; and in response to a measurement report message transmission condition configured by the first message being satisfied, transmitting the measurement report message to the serving cell, wherein the measurement report message includes first cell information about a first cell triggering transmission of the measurement report message at a time point when transmission of the measurement report message is triggered, and second cell information about a second cell having a highest signal strength at the time point when transmission of the measurement report message is triggered.

The measurement report message may further include signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

The measurement report message may further include signal strength prediction information for the first cell at a predetermined specific time point after transmission of the measurement report message is triggered, and information on a fourth cell predicted to have a highest signal strength at the predetermined specific time point after transmission of the measurement report message is triggered.

The measurement report message transmission condition may correspond to a case where a reception signal strength of the first cell is maintained higher than a reception signal strength of the serving cell during a time-to-trigger (TTT) indicated by the first message; signal strength measurement information received from the first cell may include first measurement information for a signal received from the first cell at a time point when a trigger entry condition for transmission of the measurement report message is satisfied and second measurement information for a signal received from the first cell at a time point when the TTT elapses; and signal strength measurement information received from the second cell may include third measurement information for a signal received from the second cell at the time point when the trigger entry condition for transmission of the measurement report message is satisfied, and fourth measurement information for a signal received from the second cell at a time point when the TTT elapses.

The measurement report message may further include fifth measurement information for a signal received from the serving cell at a time point when a trigger entry condition for transmission of the measurement report message is satisfied, and sixth measurement information for a signal received from the serving cell at a time point when a condition of the TTT condition is satisfied.

The measurement report message may further include information about a third cell having a highest signal strength among cells having higher signal strengths than the serving cell before transmission of the measurement report message is triggered, and information on a time point when the third cell becomes a cell having the highest signal strength.

The measurement report message may further include signal strength measurement information for the serving cell at the time point when the third cell becomes the cell with the highest signal strength.

The first message may further include a scaling value for adjusting a TTT based on a signal strength of the serving cell.

According to a second exemplary embodiment of the present disclosure, a method of a base station may comprise: transmitting, to a terminal, a first message including measurement report configuration information; receiving, from the terminal, a measurement report message based on the first message; determining a target cell to which the terminal is to be handed over based on the measurement report message; transmitting a request for a handover of the terminal to the target cell; and in response to receiving, from the target cell, a response to the request for the handover of the terminal, transmitting a handover command to the terminal, wherein the measurement report configuration information may include a condition for triggering the measurement report message and configuration information of the measurement report message to be transmitted by the terminal, and the measurement report message received from the terminal may include first cell information about a first cell triggering transmission of the measurement report message at a time point when transmission of the measurement report message is triggered, and second cell information about a second cell having a highest signal strength at the time point when transmission of the measurement report message is triggered.

The measurement report message may further include signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

The measurement report message may further include signal strength prediction information for the first cell at a predetermined specific time point after transmission of the measurement report message is triggered, and information on a fourth cell predicted to have a highest signal strength at the predetermined specific time point after transmission of the measurement report message is triggered.

The measurement report message may further include information about a third cell having a highest signal strength among cells having higher signal strengths than the serving cell before transmission of the measurement report message is triggered, and information on a time point when the third cell becomes a cell having the highest signal strength.

The measurement report message may further include signal strength measurement information for the serving cell at the time point when the third cell becomes the cell with the highest signal strength.

The first message may further include a scaling value for adjusting a TTT based on a signal strength of the serving cell.

According to a third exemplary embodiment of the present disclosure, a terminal may comprise a processor, and the processor may cause the terminal to perform: receiving, from a serving cell, a first message including measurement report configuration information; in response to transmission of a measurement report message being triggered based on the first message, generating a measurement report message; and in response to a measurement report message transmission condition configured by the first message being satisfied, transmitting the measurement report message to the serving cell, wherein the measurement report message may include first cell information about a first cell triggering transmission of the measurement report message at a time point when transmission of the measurement report message is triggered, and second cell information about a second cell having a highest signal strength at the time point when transmission of the measurement report message is triggered.

The measurement report message may further include signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

The measurement report message may further include signal strength prediction information for the first cell at a predetermined specific time point after transmission of the measurement report message is triggered, and information on a fourth cell predicted to have a highest signal strength at the predetermined specific time point after transmission of the measurement report message is triggered.

The measurement report message transmission condition may correspond to a case where a reception signal strength of the first cell is maintained higher than a reception signal strength of the serving cell during a time-to-trigger (TTT) indicated by the first message; signal strength measurement information received from the first cell may include first measurement information for a signal received from the first cell at a time point when a trigger entry condition for transmission of the measurement report message is satisfied and second measurement information for a signal received from the first cell at a time point when the TTT elapses; and signal strength measurement information received from the second cell may include third measurement information for a signal received from the second cell at the time point when the trigger entry condition for transmission of the measurement report message is satisfied, and fourth measurement information for a signal received from the second cell at a time point when the TTT elapses.

The measurement report message may further include information about a third cell having a highest signal strength among cells having higher signal strengths than the serving cell before transmission of the measurement report message is triggered, and information on a time point when the third cell becomes a cell having the highest signal strength.

The measurement report message may further include signal strength measurement information for the serving cell at the time point when the third cell becomes the cell with the highest signal strength.

In an exemplary embodiment of the present disclosure, it becomes possible to mitigate the issue of a terminal transmitting measurement reports excessively within a short time period, consequently reducing unnecessary handovers. To achieve this, when a handover event occurs, the terminal may transmit a measurement report message to a base station containing additional signal strength measurements for neighbor cells.

In this case, the measurement report message can include previously measured information and/or prediction information derived from artificial intelligence or machine learning, leading to the advantage of allowing the base station to determine a more accurate target cell during handover decision.

Moreover, under the present disclosure, the terminal can be configured to refrain from transmitting a measurement report when certain pre-defined conditions are satisfied, thereby preventing frequent handovers due to frequent measurement reports and at the same time reducing resource wastes due to performing measurement reporting and handover procedures.

Furthermore, the present disclosure provides a method for quickly performing measurement reporting before a radio link failure (RLF) occurs due to a link quality deterioration in handover, thereby preventing deterioration of communication quality due to the RLF. In addition, according to the present disclosure, by preventing occurrence of the RLF, not only the waste of radio resources can be prevented, but also the waste of power in the terminal can be prevented.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating an exemplary embodiment of a handover execution time in a communication system.

FIG. 4 is a sequence chart for describing a method for measuring and reporting reception signal strengths in a communication system.

FIG. 5 is a graph illustrating a result of simulation based on signal strength measurement results of a serving cell and neighbor cells of a terminal and handover events in an LTE UAV mobile environment.

FIG. 6 is a conceptual diagram for describing cases where A1 to A6 events occur.

FIG. 7 is a conceptual diagram for describing a criterion for determining a handover failure in 3GPP handover performance simulation.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and redundant descriptions for the same elements are omitted.

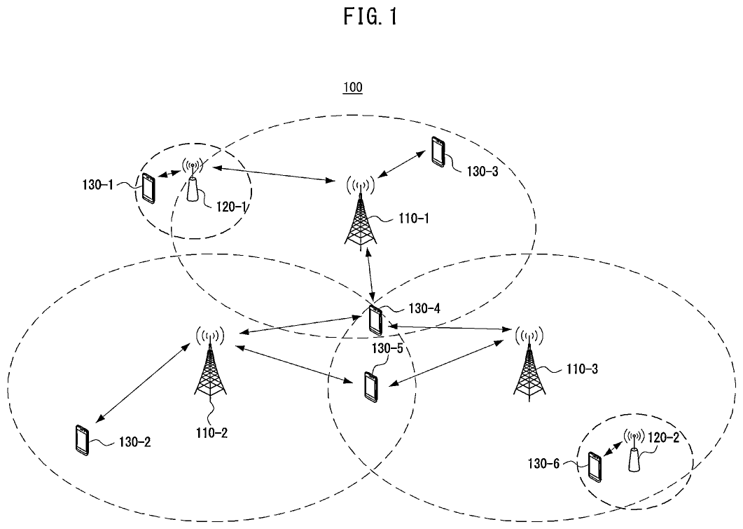

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g. long term evolution (LTE), LTE-advanced (LTE-A)), 5th generation (5G) communication (e.g. new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

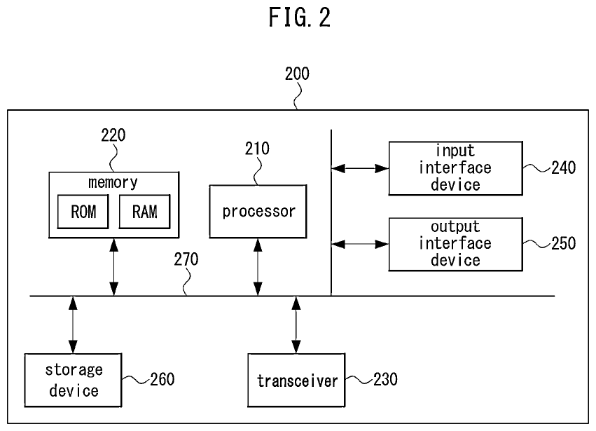

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g. a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

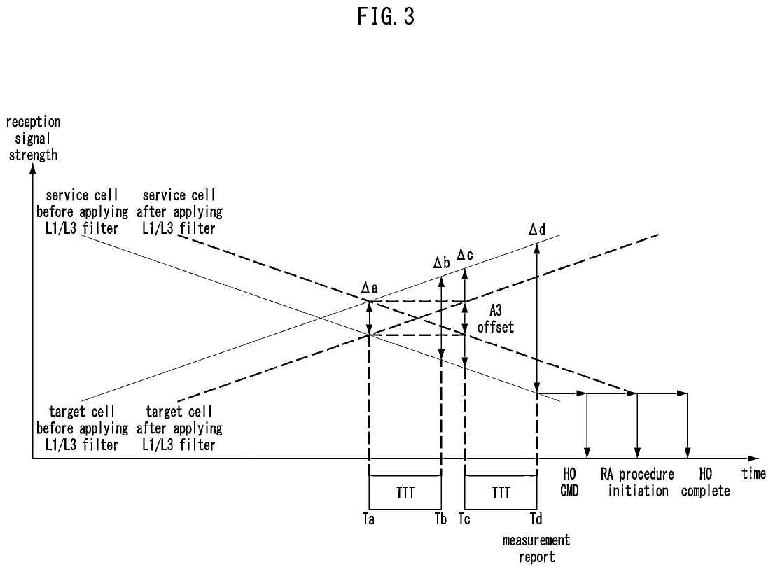

FIG. 3 is a conceptual diagram illustrating an exemplary embodiment of a handover execution time in a communication system.

Referring to FIG. 3, in a communication system such as NR and LTE, a terminal may measure reception signal strengths of a serving base station covering a serving cell and neighbor base stations including a target base station covering a target cell. Since variation in a reception signal strength on an actual radio channel may be large due to effects such as fading, the terminal may apply a first layer (i.e. layer 1 (L1)) filter to obtain an average value over a certain time period and use it as the reception signal strength. In this case, a difference Δa between a reception signal strength of the target base station and a reception signal strength of the serving base station at a time point Ta may be equal to or greater than a handover margin. In addition, a difference Δb between a reception signal strength of the target base station and a reception signal strength of the serving base station at a time point Tb may be equal to or greater than the handover margin, and Tb may be a time point after a handover trigger time elapses from the time point Ta.

Meanwhile, in order to reduce a ping-pong phenomenon and determine a reliable handover from fading effects, the terminal may further apply a third layer (i.e. layer 3 (L3)) filter to a result of applying the L1 filter. In the above-described manner, the terminal may calculate an exponential weighted average after multiplying the result of applying the L1 filter with a weight value through the L3 filter, and use the calculated exponential weighted average as a final reception signal strength. By applying such the final reception signal strength calculation scheme, the terminal may determine a handover reliable from fading effects while preventing a ping-pong phenomenon.

In this case, a difference Δc between a reception signal strength of the target base station and a reception signal strength of the serving base station at a time point Tc may be equal to or greater than the handover margin. In addition, a difference Δd between a reception signal strength of the target base station and a reception signal strength of the serving base station at a time point Td may be equal to or greater than the handover margin, and Td may be a time point after the handover trigger time elapses from the time point Tc. Ta may be a handover time with only the L1 filter applied base on an A3 offset. On the other hand, in case of further applying the L3 filter, a handover time may be delayed to Tc. If the handover trigger time is applied, the handover time may be further delayed to Td. Here, the L1 filter, L3 filter, and handover trigger time may enable the handover to be determined reliably. However, a probability of handover failure may increase due to a delay in the handover time due to the L1 filter, L3 filter, and handover trigger time.

Meanwhile, the terminal may transmit a measurement report message to the serving base station at the time point Td. The serving base station may receive the measurement report message from the terminal. The serving base station may determine a handover of the terminal based on the reception signal strengths of the serving base station and neighbor base stations included in the measurement report message. In this case, the serving base station may transmit a handover preparation message to the target base station to proceed with the handover of the terminal. The target base station may receive the handover preparation message from the serving base station, and may decide whether to accept the handover of the terminal based on the handover preparation message. When the target base station accepts the handover of the terminal, the target base station may transmit a handover preparation acknowledgement (ACK) message to the serving base station.

The serving base station may receive the handover preparation ACK message from the target base station, and the serving base station may transmit a handover (HO) command (CMD) message instructing the handover indicated by the handover preparation ACK message to the terminal. At this time, a state of a radio link between the serving base station and the terminal may be poor. As a result, a probability of handover failure may increase. Here, the HO CMD message may be included in a radio resource control (RRC) reconfiguration message transmitted from the serving base station to the terminal. The terminal may receive the HO CMD message from the serving base station. After receiving the HO CMD message, the terminal may acquire downlink synchronization with the target base station, and then transmit a random access (RA) preamble to the target base station to initiate a random access (RA) procedure. After the terminal acquires uplink synchronization through the RA procedure, the terminal may complete the handover by transmitting a handover complete message to the target base station. Here, the RA procedure may be performed when a radio link state between the target base station and the terminal is good. As a result, a probability of error occurrence in the RA procedure may be low. In addition, the handover complete message may also be transmitted when the radio link state between the target base station and the terminal is good. As a result, a probability of error occurrence in transmission of the handover complete message may be low.

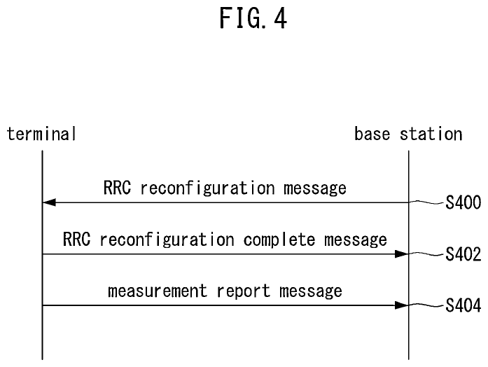

FIG. 4 is a sequence chart for describing a method for measuring and reporting reception signal strengths in a communication system.

Before referring to FIG. 4, the terminal and/or base station may include at least part or all of the components of the communication node previously described in FIG. 2. The terminal and/or base station may further include additional components other than those illustrated in FIG. 2. For example, the terminal may further include various devices for user convenience, such as a user interface device and various sensors. For example, the base station may further include an interface for communicating with a higher layer network and/or an interface for communicating with neighbor base stations and/or an interface for connecting to an operator.

Referring to FIG. 4, in step S400, the base station may generate signal strength measurement configuration information according to capabilities of the terminal, network configuration information, and/or the like. In addition, the base station may configure the signal strength measurement configuration information as a measurement configuration information element (e.g. measconfig IE) and transmit it to the terminal by including it in an RRC reconfiguration message (e.g. RRCReconfiguration). Accordingly, in step S400, the terminal may receive the RRC reconfiguration message including the measurement configuration IE from the base station.

In step S402, the terminal may transmit an RRC reconfiguration complete message to the base station in response to the RRC reconfiguration message received from the base station. Therefore, the base station may confirm that the terminal has received the RRC reconfiguration message transmitted by the base station based on the RRC reconfiguration complete message received in step S402.

The terminal may perform signal strength measurements according to the signal strength measurement configuration information included in the measurement configuration IE, and may report signal strength measurement results to the base station periodically or when an event occurs. The measurement results may be included in a measurement result IE (e.g. measResults IE).

The measurement configuration IE may be configured as shown in Tables 1 and 2 below.

TABLE 1

| -- ASN1START | | |
|---|---|---|
| -- TAG-MEASCONFIG-START | | |
| MeasConfig ::= | SEQUENCE { | |
| measObjectToRemoveList | | MeasObjectToRemoveList |
| OPTIONAL, -- Need N | | |
| measObjectToAddModList | | MeasObjectToAddModList |
| OPTIONAL, -- Need N | | |
| reportConfigToRemoveList | | ReportConfigToRemoveList |
| OPTIONAL, -- Need N | | |
| reportConfigToAddModList | | ReportConfigToAddModList |
| OPTIONAL, -- Need N | | |
| measIdToRemoveList | | MeasIdToRemoveList |
| OPTIONAL, -- Need N | | |
| measIdToAddModList | | MeasIdToAddModList |
| OPTIONAL, -- Need N | | |
| s-MeasureConfig | CHOICE { | |
| ssb-RSRP | RSRP-Range, | |
| csi-RSRP | RSRP-Range | |
| } | | OPTIONAL, -- Need |
| M | | |
| quantityConfig | QuantityConfig | OPTIONAL, |
| -- Need M | | |
| measGapConfig | MeasGapConfig | OPTIONAL, |

| -- Need M | |
|---|---|
| measGapSharingConfig | MeasGapSharingConfig |

OPTIONAL, -- Need M
...,

TABLE 2
[[

| | |
|---|---|
| interFrequencyConfig-NoGap-r16 | ENUMERATED {true} |

```
OPTIONAL -- Need R
    ]]
  }
```

| | |
|---|---|
| MeasObjectToRemoveList ::= | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId
-- TAG-MEASCONFIG-STOP
-- ASN1STOP

The measurement configuration IE in Tables 1 and 2 illustrated above may be configured as a group of parameters. In the measurement configuration IE illustrated in Table 1 and Table 2, measObjectToRemoveList may provide a list of measurement objects to be deleted. In the measurement configuration IE, measObjectToAddModList may provide a list of measurement objects to be added or modified. In the measurement configuration IE, reportConfigToRemoveList may provide a list of measurement reporting targets to be deleted. In the measurement configuration IE, reportConfigToAddModList may provide a list of measurement reporting targets to be added or modified. In the measurement configuration IE, quantityConfig may provide L3 filter configuration information. In the measurement configuration IE, measIdToRemoveList may provide a list of identifiers to be deleted from a list of measurement identifiers of measurement objects. In the measurement configuration IE, measIdToAddModList may provide a list of identifiers to be added or modified in a list of measurement identifiers of measurement objects. In the measurement configuration IE, s-MeasureConfig may be a configuration that prevents measurement of neighbor cells from being performed when the reception signal strength of the serving cell is equal to or greater than a certain threshold.

In step S404, the terminal may measure reception signal strengths (e.g. reference signal received power (RSRP), reference signal received quality (RSRQ), or signal to interference-plus-noise ratio (SINR)) of neighbor base stations according to the signal strength measurement configuration information of the measurement configuration IE. In addition, the terminal may periodically report signal strength measurement results, including the measured reception signal strengths of neighbor base stations, to the base station through a measurement report message according to the measurement report configuration. As another example, when a reception signal strength of a neighbor base station satisfies a specific event according to the measurement report configuration, the terminal may report the signal strength measurement results, including the measured reception signal strength of the neighbor base station, to the base station through a measurement report message. The measurement report message may be configured as shown in Table 3 below.

TABLE 3

| -- ASN1START | | |
|---|---|---|
| -- TAG-MEASUREMENTREPORT-START | | |
| MeasurementReport ::= | SEQUENCE { | |
| criticalExtensions | CHOICE { | |
| measurementReport | MeasurementReport-IEs, | |
| criticalExtensionsFuture | SEQUENCE { } | |
| } | | |
| } | | |
| MeasurementReport-IEs ::= | SEQUENCE { | |
| measResults | MeasResults, | |
| lateNonCriticalExtension | | OCTET STRING |
| OPTIONAL, | | |
| nonCriticalExtension | SEQUENCE{ } | OPTIONAL |

}
-- TAG-MEASUREMENTREPORT-STOP
-- ASN1STOP

Then, the base station may receive the measurement report message from the terminal. Here, the measurement report message may include measurement results IE (e.g. measResults IE), which includes the signal strength measurement results. The measurement results IE may be as shown in Tables 4 to 6 below.

TABLE 4
-- ASN1START
-- TAG-MEASRESULTS-START

| MeasResults ::= | SEQUENCE { |
|---|---|
| measId | MeasId, |
| measResultServingMOList | MeasResultServMOList, |

| | |
|---|---|
| measResultNeighCells | CHOICE { |
| measResultListNR | MeasResultListNR, |

...,

| measResultListEUTRA | MeasResultListEUTRA, | |
|---|---|---|
| measResultListUTRA-FDD-r16 | MeasResultListUTRA-FDD-r16, | |
| sl-MeasResultsCandRelay-r17 | OCTET STRING | -- Contains PC5 SL- |

MeasResultListRelay-r17

| | |
|---|---|
| } | OPTIONAL, |

...,

TABLE 5
[[

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
      ]],
      [[
```

| | |
|---|---|
| measResultCellListSFTD-NR | MeasResultCellListSFTD-NR |

OPTIONAL
]],

TABLE 6
[[

| | |
|---|---|
| measResultForRSSI-r16 | MeasResultForRSSI-r16 |

OPTIONAL,

| | |
|---|---|
| locationInfo-r16 LocationInfo-r16 | OPTIONAL, |
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
    ]],
    [[
```

| | |
|---|---|
| measResultRxTxTimeDiff-r17 | MeasResultRxTxTimeDiff-r17 |

OPTIONAL,

| | |
|---|---|
| sl-MeasResultServingRelay-r17 | OCTET STRING |

OPTIONAL,

-- Contains PC5 SL-

MeasResultRelay-r17

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

```
OPTIONAL
    ]]
  }
```

The measurement results IE illustrated in Tables 4 to 6 above may be configured as a group of parameters. In the measurement results IE, MeasResultServMOList may be configured as shown in Table 7 below.

TABLE 7

| | |
|---|---|
| MeasResultServMOList ::= | SEQUENCE (SIZE (1..maxNrofServingCells)) OF |

MeasResultServMO

| | |
|---|---|
| MeasResultServMO ::= | SEQUENCE { |
| servCellId | ServCellIndex, |
| measResultServingCell | MeasResultNR, |

| | |
|---|---|
| measResultBestNeighCell | MeasResultNR |

```
OPTIONAL,
    ...
  }
```

MeasResultServMO IE may include signal strength measurement results for measurement objects configured for each serving cell (e.g. SpCell and/or SCell). Optionally, it may include a signal strength measurement result of the best neighbor cell for each serving cell measurement object.

In case of the LTE system, the measurement report message transmitted by the terminal may include the signal strength measurement results for the serving cell and the best neighbor cell as shown in Tables 8 and 9 below.

```
TABLE 8
UL-DCCH-Message ::= {
  message: cl: measurementReport: MeasurementReport ::= {
    criticalExtensions: cl: measurementReport-r8: MeasurementReport-r8-IEs ::= {
      measResults: MeasResults ::= {
        measId: 2
        measResultPCell: measResultPCell ::= {
          rsrpResult: 19
          rsrqResult: 6
        }
        measResultNeighCells: measResultListEUTRA: MeasResultListEUTRA ::= {
          MeasResultEUTRA ::= {
            physCellId: 284
            measResult: measResult ::= {
              rsrpResult: 20
              rsrqResult: 17
            }
          }
          MeasResultEUTRA ::= {
            physCellId: 288
            measResult: measResult ::= {
              rsrpResult: 17
              rsrqResult: 8
            }
          }
        }
```

```
TABLE 9
        measresults-ext0: measresults-ext0 ::= {
        }
        measresults-ext1: measresults-ext1 ::= {
          measResultServFreqList-r10: MeasResultServFreqList-r10 ::= {
            MeasResultServFreq-r10 ::= {
              servFreqId-r10: 1
              measResultSCell-r10: measResultSCell-r10 ::= {
                rsrpResultSCell-r10: 27
                rsrqResultSCell-r10: 20
              }
              measResultBestNeighCell-r10: measResultBestNeighCell-r10 ::= {
                physCellId-r10: 284
                rsrpResultNCell-r10: 26
                rsrqResultNCell-r10: 19
              }
            }
          }
        }
      }
    }
  }
}
```

The signal strength measurement result for the best neighbor cell may correspond to the IE underlined in bold in Table 9 above.

Hereinafter, an A3 event measurement reporting-based handover will be described.

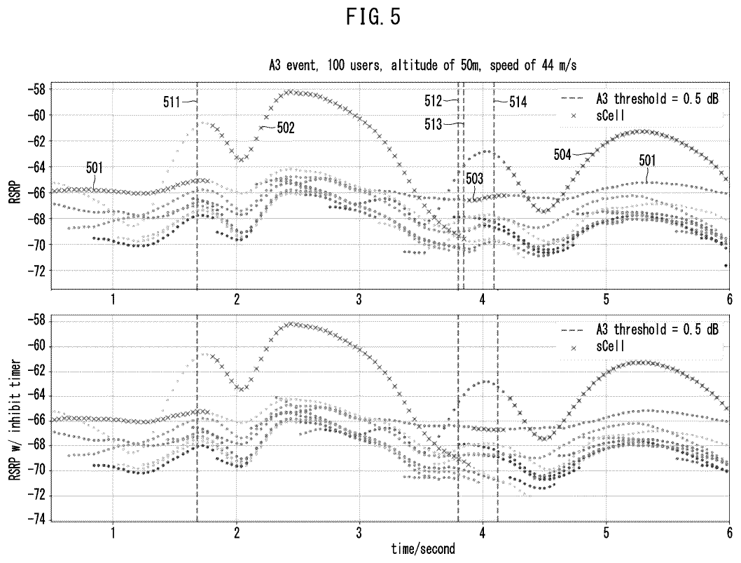

FIG. 5 is a graph illustrating a result of simulation based on signal strength measurement results of a serving cell and neighbor cells of a terminal and handover events in an LTE UAV mobile environment.

That is, FIG. 5 corresponds to a graph showing a result of simulation of A3 events when assuming that an LTE unmanned aerial vehicle (UAV) moves at 44 m/s in an altitude of 50 m, an A3 handover threshold is 0.5 dB, and 100 users exist in the environment.

The simulation graph in FIG. 5 may be divided into an upper simulation graph and a lower simulation graph. The upper simulation graph shows a result of simulation based on A3 handover events, and the lower simulation graph shows a result of simulation using an inhibit timer.

In FIG. 5, serving cells may correspond to base stations with an RSRP value indicated by ‘x’. Description below will be made using the upper simulation graph among the simulation graphs in FIG. 5. When a first serving cell is a cell A 501, the cell A 501 may start as a serving cell of a UAV terminal. The horizontal axis may represent the passage of time according to movement of the UAV terminal. In the following description, the UAV terminal will be referred to as a terminal.

In the simulation, the cell A 501 may be the serving cell of the terminal until a handover occurs due to an A3 event triggering a first measurement report message 511.

Thereafter, when transmitting the first measurement report message 511, the terminal may report an RSRP value of the serving cell and an RSRP value of a neighbor cell to the cell A 501, which is the serving cell. At this time, the neighbor cell may be a cell with the highest RSRP value. The neighbor cell may be assumed as a cell B 502. The cell A 501, which is the serving cell, may perform a handover procedure to the cell B 502 based on the measurement report message as previously described in FIGS. 3 and 4. Accordingly, after a certain time period, the terminal may perform a handover from the cell A 501 to the cell B 502.

As the terminal moves again, A3 events may occur sequentially, as indicated by reference numerals 512 and 513. Then, the terminal may transmit measurement report messages to the cell B 502, which is the serving cell, based on the occurrences of the A3 event. Based on this, the cell B 502 may determine a handover of the terminal. A target cell determined at the time point 512 may be assumed as a cell C 503. Once the target cell is determined, the terminal may perform a handover as previously described in FIGS. 3 and 4. In other words, the terminal may perform a handover from the cell B 502 to the cell C 503.

An A3 event may occur again, as indicated by a reference numeral 514. Accordingly, the terminal may transmit a measurement report message to the cell C 503, which is the serving cell. The measurement report message may include information on a cell with the highest RSRP value (i.e. cell having the best channel state with the terminal), as described above. When the cell with the highest RSRP value is a cell D 504, the cell C 503, which is the serving cell, may determine the cell D 504 as a target cell, and transmit to the terminal a HO CMD message instructing a handover to the cell D 504. The terminal may receive the HO CMD message from the cell C 503 which is the serving cell. The terminal may proceed with a handover procedure from the cell C 503 to the cell D 504 based on the HO CMD message.

According to the upper simulation graph of FIG. 5 described above, it can be seen that four A3 events occur when the A3 threshold is 0.5 dB. In other words, the terminal needs to transmit four measurement report messages to the base station. Accordingly, the terminal may perform a handover procedure from the cell A 501 to the cell B 502, a handover procedure from the cell B 502 to the cell C 503, and a handover procedure form the cell C 503 to the cell D 504. In other words, a total of three handovers may occur for the terminal.

The lower simulation graph of FIG. 5 may correspond to a case where an inhibit timer is set. It can be seen that the inhibit timer causes the measurement report messages to be transmitted only three times in the same environment, that is, when the A3 threshold is set to 0.5 dB. In addition, the handovers may be performed in the same manner.

### (1) Terminal Measurement Report Including Additional Information

The present disclosure proposes methods for preventing the terminal from frequently transmitting measurement report messages within a short time period in the situation described above. In addition, the present disclosure proposes methods for reducing unnecessary handovers.

According to the present disclosure, the terminal may transmit a measurement report message to the base station, and the base station may determine a handover based on the measurement report message received from the terminal. The measurement report message according to the present disclosure may include information on a cell triggering the measurement report at a time point when the measurement report is triggered and information on the best neighbor cell among neighbor cells measured at the time point when the measurement report is triggered. In the following description, information on a cell will be described as including a cell identifier that can identify the cell and a measurement value (or measurement information) measured by the terminal for the cell. The best neighbor cell may be, for example, a cell with the highest RSRP value. In other words, the terminal according to the present disclosure may transmit a measurement report to the base station at the time point when the measurement report is triggered, and the measurement report message may include information on the best neighbor cell and information on a neighbor cell triggering the measurement report.

According to an exemplary embodiment of the present disclosure, when reporting measurement results, the terminal may transmit, to the base station, a measurement report message including information on a first cell (i.e. first cell information) and information on a second cell (i.e. second cell information) at the time point when the measurement report is triggered. At this time, the base station may be a serving cell. In the above example, the first cell may be a cell triggering the measurement report, and the second cell may be a neighbor cell with the highest RSRP value at the time point when the measurement report is triggered.

According to another exemplary embodiment of the present disclosure, when reporting measurement results, the terminal may transmit, to the base station, a measurement report message including information on a third cell (i.e. third cell information) and information on a fourth cell (i.e. fourth cell information) in addition to the first cell information and the second cell information. At this time, the base station may be a serving cell. Here, the first cell may be a cell triggering the measurement report, and the second cell may be a neighbor cell with the highest signal strength at the time point when the measurement report is triggered. In addition, the third cell information may be cell information on the first cell at the most recent time point measured before the measurement report is triggered, and the fourth cell information may cell information on the best neighbor cell at the time point of the third cell information. Therefore, the second cell and the fourth cell may be the same cell or may be different cells.

According to another exemplary embodiment of the present disclosure, when reporting measurement results, the terminal may transmit, to the base station, a measurement report message including information on a fifth cell (i.e. fifth cell information) and information on a sixth cell (i.e. sixth cell information) in addition to the first cell information and second cell information. At this time, the base station may be a serving cell. Here, the first cell may be a cell that triggering the measurement report, and the second cell may be a neighbor cell with the highest signal strength at the time point when the measurement report is triggered. In addition, the fifth cell information may be information on a signal strength prediction result for the first cell at a time after a predetermined time from the time point when the measurement report is triggered, and the sixth cell may be a cell predicted to have the highest signal strength at the time of the fifth cell information. Therefore, the second cell and the sixth cell may be the same cell or may be different cells.

According to another exemplary embodiment of the present disclosure, when reporting measurement results, the terminal may transmit, to the base station, a measurement report including the first cell information, second cell information, third cell information, fourth cell information, fifth cell information, and sixth cell information. At this time, the base station may be a serving cell. In addition, the first to sixth cell information may be information on the cells defined above.

The base station receiving the measurement report message based on one of the methods exemplified above can determine a handover for the terminal more quickly and accurately than the existing handover decision.

When using at least one of the methods exemplified above, the base station can reduce unnecessary handovers of the terminal. In addition, the base station can improve communication quality in the handover region by quickly deciding the handover before a link state between the terminal and the serving cell deteriorates. Further, when using at least one of the methods described above, the terminal can reduce frequent measurement reporting within a short time period. Accordingly, the base station can reduce the overhead of frequent handovers for the terminal. In other words, using at least one of the methods described above can have the effect of preventing resource waste in the communication system.

A comparison may be made using the methods according to the present disclosure described above in the same environment as the simulation environment of FIG. 5 described above. In the optimal case in which the present disclosure is applied in the environment of FIG. 5, the measurement report may be triggered only once and a handover may occur only once in a period after a time point indicated by the reference numeral 511.

When using the method according to the present disclosure, a case where the serving cell B 502 is a serving cell for a UAV that is a terminal will be described. One measurement report may be transmitted at a transmission time 512 of the second measurement report message in FIG. 5. In other words, the measurement report message may be transmitted to the base station when an A3 handover event occurs by comparing a RSRP value of the serving cell B 502 and a RSRP value of the serving cell C 503. In this case, unlike the existing scheme, the terminal according to the present disclosure may report a signal strength measurement value for a cell D 504 (i.e. the best cell) having the highest RSRP value at a start time of TTT that is before the time point 512 when the measurement report is triggered. In other words, the measurement report message transmitted from the terminal to the base station may include a signal strength measurement value for the cell C 503 and a signal strength measurement value for the cell D 504. The source base station receiving the measurement report message may determine the cell D 504, rather than the cell C 503, as a target cell according to the handover decision algorithm according to the present disclosure.

As another example, the source base station may predict a signal strength of the cell C 503 (i.e. first neighbor cell) and a signal strength of the cell D 504 (i.e. second neighbor cell) after a short time period by using machine learning, etc. The source base station may determine the cell D 504 (i.e. second neighbor cell) as a handover target cell for the terminal based on the signal strength prediction results. The serving cell may transmit a HO CMD message including information on the handover target cell to the UAV that is a terminal. The terminal receiving the HO CMD message may attempt a handover to the cell D 504, which is the target cell indicated by the HO CMD message. Accordingly, unlike those described in FIG. 5, according to the present disclosure, additional handovers can be prevented.

### (2) Terminal Measurement Report Including Event-Based Additional Information

A terminal measurement report message including event-based additional information described below may include information on the best neighbor cell, and additional signal strength measurement results and/or signal strength prediction results for other neighbor cells at a time when a measurement report event occurs.

According to an exemplary embodiment, the measurement report message transmitted from the terminal to the base station may include first measurement information at a first time point when an event entry condition of an event is satisfied and second measurement information at a second time point when a TTT of the event is satisfied. In this case, the first measurement information at the first time point may include measurement information for the first neighbor cell triggering the entry condition of the event and measurement information for the second neighbor cell with the highest signal strength. In addition, the second measurement information at the second time point may include measurement information for the first neighbor cell triggering the entry condition of the event and measurement information for the second neighbor cell with the highest signal strength at a time when the TTT is satisfied after the entry condition. It may further include measurement information for the serving cell at the first time point and measurement information for the serving cell at the second time point.

According to another exemplary embodiment, the measurement report message may include first measurement information at the first time point when the event entry condition is satisfied and second measurement information at the second time point when satisfies the TTT of the event is satisfied, and may further include additional auxiliary information. The additional auxiliary information may determine N (N may be 0 or a natural number) predetermined time point(s) between the first time point and the second time point, and measurement information at each of the determined N time point(s) may include measurement information for the first neighbor cell triggering the event entry condition and measurement information for the second neighbor cell with the highest signal strength. In addition, the measurement report message may further include the signal strength measurement results for the serving cell at each of the N time points as additional information.

Meanwhile, if N is set to 0, the measurement report message may have a form including only information for the first time point and the second time point.

In another exemplary embodiment, there may occur a case where a measurement result of a signal strength is not valid but a prediction result therefor is valid at each of the first time point, the second time point, and the N time point(s) between the first time point and the second time point. If a measured specific signal strength is not valid and a prediction result therefor is valid at a specific time point, the terminal may include the prediction result rather than the measured signal strength based on configuration information configured by the base station to the terminal.

When configuring signal strength measurement information for the terminal, the base station may configure the terminal to report additional signal strength measurement information for a neighbor cell having the best channel state (e.g. having the highest reception signal strength) and/or a neighbor cell in which an event occurs. As one of these configuration methods, the base station may configure the terminal to report signal the strength measurement information by using an RRC reconfiguration message, as previously described in FIG. 4. For example, the base station may use the measconfig IE included in the RRC reconfiguration message described above. More specifically, in order to indicate signal strength measurement objects, the base station may configure measurement objects to the terminal by using reportConfigToAddModList, which indicates a list of measurement objects to be added or modified, within the measconfig IE.

### (3) Terminal Measurement Report Including Best Cell-Based Additional Information

Hereinafter, methods for configuring a terminal measurement report message that includes best cell-based additional information.

According to an exemplary embodiment of the present disclosure, the terminal may generate a terminal measurement report message based on the configuration of the base station as described above and transmit it to the base station. At this time, the terminal measurement report message may include information on the best neighbor cell at a time point when an event occurs, and additional signal strength measurement results and/or prediction results for a neighbor cell where the event occurs.

As an example, the measurement report message may include information on one time point and a signal strength measurement result for the best neighbor cell (e.g. the neighbor cell with the highest reception signal strength) at a time point when a measurement report event occurs. Here, the information on the one time point may indicate another cell other than the serving cell. The another cell other than the serving cell may mean the best cell (e.g. the cell with the highest reception signal strength), and the one time point may be a time point when the another cell becomes the best cell. In this case, it may be assume that the information on the one time point indicates a time point T1 and the time point when the measurement report event is triggered is a time point T2. In this case, the best neighbor cell may be assumed as a cell #1.

The measurement report message may include time information on the time point T1 and measurement result information for the cell #1 at the time point T2. In addition, the measurement report message according to the present disclosure may further include a signal strength measurement result for the serving cell at the time point T1 and a signal strength measurement result for the serving cell at the time point T2.

The measurement report message may further include information defining N measurement time point(s) (where N is 0 or a natural number) between the time point T1 and the time point T2, and may further include measurement results for the cell #1 at the N time point(s). In addition, the measurement report message may further include a strength measurement result for the serving cell at each of the N time points.

The measurement report message may include a signal strength measurement result for the best neighbor cell at each of the N measurement time points (where N is 0 or a natural number) between the time point T1 and the time point T2. Further, the measurement report message may further include a signal strength measurement result for the serving cell at each of N measurement time points (where N is 0 or a natural number) between the time point T1 and the time point T2. Here, if N is set to 0, the measurement report message may not include information for the N measurement time points.

Meanwhile, there may occur a case where a measurement result of a signal strength is not valid and a prediction result therefor is valid at a specific time point. In this case, if the base station configures such that prediction result can be included in a measurement report message, the terminal may generate the measurement report message including the prediction result rather than the invalid measurement result.

When configuring signal strength measurement information for the terminal, the base station may configure the terminal to report additional signal strength measurement information for a neighbor cell having the best channel state (e.g. having the highest reception signal strength) and/or a neighbor cell in which an event occurs. As one of these configuration methods, the base station may configure the terminal to report signal the strength measurement information by using an RRC reconfiguration message, as previously described in FIG. 4. For example, the base station may use the measconfig IE included in the RRC reconfiguration message described above. More specifically, in order to indicate signal strength measurement objects, the base station may configure measurement objects to the terminal by using reportConfigToAddModList, which indicates a list of measurement objects to be added or modified, within the measconfig IE.

### (4) Terminal Measurement Report Based on Neighbor Cell Signal Strength Event

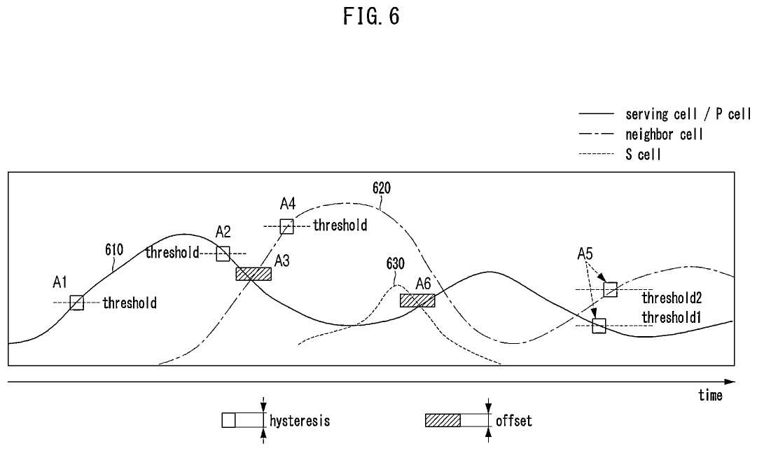

Events based on signal strengths of neighbor cells (hereinafter, ‘neighbor cell signal strength event’) may exist in various forms. Hereinafter, a terminal measurement report using several events will be described with reference to FIG. 6.

FIG. 6 is a conceptual diagram for describing cases where A1 to A6 events occur.

In FIG. 6, a horizontal axis may represent time, and a vertical axis may represent a signal strength value of a specific cell measured by a terminal, for example, an RSRP value. When the terminal moves, the terminal may measure strength(s) of signal(s) received from one cell or a plurality of cells. As shown in FIG. 6, the terminal may identify occurrence of an A1 event while measuring a reception signal strength 610 of a serving cell. The A1 event may correspond to a case where the reception signal strength of the serving cell becomes better than a threshold, and may correspond to a case where the reception signal strength of the serving cell becomes higher than a preset A1 event threshold. In this case, for the A1 event, a hysteresis may be configured based on the threshold value. The hysteresis may be configured to prevent the A1 event from occurring repeatedly several times based on small signal fluctuations.

As shown in FIG. 6, the reception signal strength of the serving cell may continuously change as time passes (which may include movement of the terminal). Thereafter, the terminal may identify occurrent of an A2 event at a specific time point. The A2 event may correspond to a case where the reception signal strength of the serving cell becomes worse than a threshold, and may correspond to a case where the reception signal strength of the serving cell at the terminal is lower than the threshold set for the A2 event. Also in case of the A2 event, a hysteresis may be configured to prevent the A2 event from occurring repeatedly. As shown in FIG. 6, a reception signal strength 620 of a neighbor cell may be measured even before the A2 event occurs.

As the terminal moves (or time passes) and a time point at which the reception signal strength 620 of the neighbor cell becomes a larger value than the reception signal strength 610 of the serving cell arrives, an A3 event may occur when the reception signal strength 620 of the neighbor cell is greater than the reception signal strength 610 of the serving cell by a certain offset value. That is, the A3 event may occur when the reception signal strength of the neighbor cell is higher than the reception signal strength of the serving cell by the offset value. At this time, the serving cell may configure the neighbor cell as a target cell and transmit a HO CMD message to the terminal. Then, the terminal may be handed over to the neighbor cell.

For convenience of description, the following description will be made assuming a state before the terminal is handed over. Accordingly, the neighbor cell may become a serving cell due to a handover occurring based on the A3 event, but will be described below as the neighbor cell.

As the terminal continues to move, an A4 event may occur for the neighbor cell. The A4 event may correspond to a case where the reception signal strength of the neighbor cell becomes higher than a preset A4 event threshold.

As the terminal continues to move, as shown in FIG. 6, the reception signal strength of the neighbor cell may become lower than the reception signal strength of the serving cell, but a specific event may not occur. In this situation, the terminal may identify occurrence of an A5 event. The A5 event may correspond to a case where the reception signal strength of the serving cell becomes worse than a first threshold and the reception signal strength of the neighbor cell becomes better than a second threshold. In other words, the A5 event may correspond to a case where the serving cell has a reception signal strength lower than the first threshold set for the A5 event and the neighbor cell has a reception signal strength higher than the second threshold set for the A5 event.

Meanwhile, when carrier aggregation (CA) is used, the terminal may identify occurrence of an A6 event. The A6 event may correspond to a case where the reception signal strength of the neighbor cell is better (or higher) than the reception signal strength of the serving cell by an offset set for the A6 event.

In general, a measurement report event may be configured to be triggered when the A3 event, in which a reception signal strength of a specific neighbor cell is better than that of the serving cell by a predetermined offset, is maintained for a TTT.

In the above-described situation, in order to prevent the terminal from frequently transmitting measurement report messages to the base station within a short time period and in order to reduce unnecessary handovers, events related to signal strengths of the best neighbor cell and neighbor cells in which an event occurs may be defined as exemplified in FIG. 6. In addition, the base station may configure the terminal to trigger a terminal measurement report based on each of the events illustrated in FIG. 6.

An event entry condition for a neighbor cell reception signal strength event may be expressed as Equation 1 below. For example, a neighbor cell that satisfies the event entry condition for triggering a measurement report may be assumed as a first neighbor cell, and a neighbor cell with the best reception signal strength (e.g. the highest reception signal strength) based on signal strength measurement results at the terminal may be assumed as a second neighbor cell.

$$Mb + Ofb + Ocb - Hys > Mn + Ofn + Ocn + Off \qquad [ Equation 1 ]$$

In Equation 1, Mb may indicate a result of measuring a reception signal strength of the second neighbor cell, Ofb may indicate a measurement object specific offset of the second neighbor cell, Och may indicate a cell specific offset of the second neighbor cell, Hys may indicate a hysteresis of the event, Mn may indicate a measurement result for the first neighbor cell, Ofn may indicate a measurement object specific offset of the first neighbor cell, Ocn may indicate a cell specific offset of the first neighbor cell, and Off may indicate a offset of the event.

Assuming the case of FIG. 5 described above based on Equation 1, the terminal measurement reporting method according to the present disclosure, which triggers a measurement report based on the neighbor cell reception signal strength event may trigger one measure report in an optimal case during a period after the time point indicated by the reference numeral 511. Therefore, only one handover may occur when the measurement report according to the present disclosure is triggered.

For example, values of the measurement object specific offset Off and hysteresis Hys of the first neighbor cell, which are factors in Equation 1, may be set to 0, and the TTT remaining after the event occurs for the first neighbor cell may be set as a TTT. In this case, in the example of FIG. 5, the A3 event may not occur three times, such as 512, 513, and 514, and only one measurement report may be triggered in response to the A3 event. In other words, the terminal may perform only one handover in response to the A3 event, and the measurement report may be transmitted at the time point when the A3 event occurs.

In the example of FIG. 5, unlike the methods described above, not only an A3 event for the first neighbor cell but also an A3 event for the second neighbor cell may occur simultaneously. In other words, the A3 event for the cell C 503 and the A3 event for the cell D 504 may occur simultaneously. Accordingly, the terminal may transmit, to the cell B 502 which is the current serving cell, a measurement report message including measurement report information on a reception signal strength of the cell C 503 and measurement report information on a reception signal strength of the cell D 504.

The cell B 502 which is the serving cell receiving the measurement report message including the measurement report information for the cell C 503 and cell D 504 may determine the cell D 504 (i.e. second neighbor cell), rather than the cell C 503 (i.e. first neighbor cell), as a target cell according to a handover decision algorithm. Accordingly, the cell B 502 may transmit a HO CMD message instructing the terminal to perform a handover to the cell D 504.

The terminal may receive, from the cell B 502 which is the serving cell, the HO CMD message instructing to perform a handover to the cell D 504. Accordingly, the terminal may perform the handover to the cell D 504 (i.e. second neighbor cell). As the terminal performs the handover to the cell D 504, the terminal may not need to transmit measurement report messages such as reference numerals 513 and 514. Since a handover to the cell C 503 does not occur, the number of handovers is also reduced.

In this case, as described in the above exemplary embodiments, the measurement report message may include reception signal strength measurement results for other neighbor cell(s) at a time point when the measurement report is triggered and at a time point before that. As described above, the measurement report message may include a signal strength prediction result for a specific cell, rather than a reception signal strength measurement result for the specific cell, based on configuration information from the base station.

As another example, the measurement report message may include reception signal strength measurement results for other neighbor cell(s) at the time when the measurement report is triggered and at a time point after that. As described above, the measurement report message may include a signal strength prediction result for a specific cell, rather than a reception signal strength measurement result for the specific cell, based on configuration information from the base station.

For each case of the above-described cases, the base station (or serving cell) may determine a more accurate handover target based on information on signal strengths included in the measurement report.

The base station may provide specific configuration information to the terminal for the terminal measurement reporting method based on the neighbor cell signal strength event. The configuration information may further include configuration information of the neighbor cell signal strength event in addition to the signal strength measurement configuration information. As one of methods therefor, the base station may include the configuration information in the parameter reportConfigToAddModList, which provides a list of measurement reporting targets to be added or modified, within the measurement configuration IE (measConfig IE) included in the RRC reconfiguration message. The configuration information may include the offset Off and hysteresis Hys values of the event described in Equation 1. Additionally, the configuration information may further include a TTT value.

When the event is configured, the terminal may measure a reception signal strength from a specific cell according to the configured information and determine whether the neighbor cell signal strength event occurs. When the event occurs, the terminal may determine whether it is required to transmit a measurement report message to the base station. If a measurement report message needs to be transmitted, the terminal may transmit a measurement report message to the base station based on the above configuration.

As another method, the base station may configure the terminal to include a measurement result for the second neighbor cell in the measurement report message when a preconfigured condition is satisfied. In this case, the preconfigured condition may be configured with a specific threshold. For example, the preconfigured condition may be configured as a case where a reception signal strength of the second neighbor cell is higher than a reception signal strength of the first neighbor cell by a preset specific threshold or more. Therefore, the terminal may include information on the second neighbor cell in the measurement report message if the preconfigured condition is satisfied. On the other hand, if the preconfigured condition is not satisfied, the terminal may not include information on the second neighbor cell in the measurement report message.

For example, the Hys value may be set to 0, the Off value may be set to 2 dB, and the TTT value may be set to 0. As another example, the Hys value may be set to 0, and the TTT value may be set to a TTT remaining after the event for the first neighbor cell occurs.

When configured as one of the two examples above, the A3 event may not occur three times, such as 512, 513, and 514 in the example of FIG. 5, and only one measurement report may be triggered in response to the A3 event. In other words, the terminal may only perform one handover in response to the A3 event, and the measurement report may be transmitted at a time point when the A3 event occurs.

In this case, unlike the methods described above, the measurement report message may include information on not only the A3 event for the first neighbor cell but also the A3 event for the second neighbor cell simultaneously. Therefore, the terminal may report, to the base station, measurement information for the first neighbor cell and measurement information for the second cell by using one measurement report message. The base station (serving cell) may determine a handover of the terminal based on information included in the measurement report message received from the terminal. In other words, the source base station receiving the measurement report message may determine the second neighbor cell, rather than the first neighbor cell, as a target cell for the handover according to the handover decision algorithm.

According to the above results, the terminal may perform a handover to the second neighbor cell. Therefore, there is no need to transmit an additional measurement report message to the base station as shown in FIG. 5. In addition, the terminal may perform only one handover.

As previously described in the above example, the measurement report message may include reception signal measurement result(s) of other neighbor cell(s) at a time point when the measurement report is triggered and at a time point before that. As described above, the measurement report message may include a signal strength prediction result for a specific cell, rather than a reception signal strength measurement result for the specific cell, based on configuration information from the base station.

As another example, the measurement report message may include reception signal strength measurement results for other neighbor cell(s) at the time point when the measurement report is triggered and at a time point after that. As described above, the measurement report message may include a signal strength prediction result for a specific cell, rather than a reception signal strength measurement result for the specific cell, based on configuration information from the base station.

For each case of the above-described cases, the base station (or serving cell) may determine a more accurate handover target based on signal strength information included in the measurement report.

### (5) Terminal Measurement Report Based on Best Cell Change Event

In the situations described above, a best neighbor cell change event important for handover decision may be defined to prevent the terminal from frequently transmitting measurement reports within a short time period and to reduce unnecessary handovers. Based on the best neighbor cell change event, the terminal may trigger a measurement report.

Referring again to the example of FIG. 5, similarly to the exemplary embodiments described above, a terminal measurement reporting method for triggering a measurement report based on a best cell change event may trigger one measurement report and only one handover may occur. For example, the Hys value may be set to 2 dB, and the TTT value may be set to 0. In this case, the one measurement report may be transmitted at a time point similar to the first measurement report, that is a time point when an event in which a reception signal strength of the second neighbor cell is higher than a reception signal strength of the first neighbor cell by 2 dB occurs. At this time, the terminal may further include a signal strength measurement result for the second neighbor cell in the measurement report message.

The base station receiving the measurement report message further including the signal strength measurement result for the second neighbor cell may determine the second neighbor cell, rather than the first neighbor cell, as a handover target cell for the terminal according to the handover decision algorithm described above.

When the terminal receives, from the base station, a HO CMD message instructing a handover to the second neighbor cell, the terminal may perform the handover to the second neighbor cell. Accordingly, the terminal may not transmit an additional measurement report message as shown in FIG. 5, and no additional handover occurs.

In this case, as described in the above exemplary embodiments, the measurement report message may include reception signal strength measurement results for other neighbor cell(s) at a time point when the measurement report is triggered and at a time point before that. As described above, the measurement report message may include a signal strength prediction result for a specific cell, rather than a reception signal strength measurement result for the specific cell, based on configuration information from the base station.

As another example, the measurement report message may include reception signal strength measurement results for other neighbor cell(s) at the time when the measurement report is triggered and at a time point after that. As described above, the measurement report message may include a signal strength prediction result for a specific cell, rather than a reception signal strength measurement result for the specific cell, based on configuration information from the base station.

For each case of the above-described cases, the base station (or serving cell) may determine a more accurate handover target based on information on signal strengths included in the measurement report.

For the best cell change event-based terminal measurement reporting method, the base station may provide configuration information on the best cell change event to the terminal by including it in the signal strength measurement configuration information of the terminal.

As a method for including the best cell change event configuration information in the signal strength measurement configuration information of the terminal, the configuration information may further include neighbor cell signal strength event configuration information in addition to the signal strength measurement configuration information of the terminal. As one method for this, the base station may include the corresponding configuration information in a parameter reportConfigToAddModList, which provides a list of measurement reporting targets to be added or modified, within the measurement configuration IE (i.e. measConfig IE) included in the RRC reconfiguration message. The configuration information may include the offset value Off and hysteresis value Hys of the event described in Equation 1. The configuration information may further include a TTT value.

When the event is configured, the terminal may determine whether the best cell change event occurs by measuring a reception signal strength of a specific cell according to the configured information. When the event according to the present disclosure occurs, the terminal may determine whether a measurement report message needs to be transmitted to the base station. If a measurement report message needs to be transmitted, the terminal may transmit a measurement report message to the base station based on the configuration.

As another method, the best cell change event described above may be configured by defining an event based on signal strengths of the serving cell and the best cell (i.e. serving cell/neighbor cell signal strength event), and the terminal may be configured to trigger a measurement report based on the event. An event entry condition for the event based on signal strengths of the serving cell and the best cell may be expressed as in Equation 2 below. For description below, it is assumed that a neighbor cell with the best signal strength according signal strength measurement is referred to as the second neighbor cell.

$$Mb + Ofb + Ocb - Hys > Mp + Ofp + Ocp + Off \qquad [ Equation 2 ]$$

In Equation 2, Mb may indicate a measurement result for the second neighbor cell, Ofb may indicate a measurement object specific offset of the second neighbor cell, Och may indicate a cell specific offset of the second neighbor cell, and Hys may indicate a hysteresis of the event. In addition, Mp may indicate a measurement result for the serving cell, Ofp may indicate a measurement object specific offset of the serving cell, Ocp may indicate a cell-specific offset of the serving cell, and Off may indicate an offset of the event.

The best cell may change before the TTT of the event is satisfied. When determining an event for the serving cell and a new best cell, an elapsed TTT for the event based on signal strengths of the serving cell and the existing best cell may be configured to be considered or ignored.

For example, Off and Hys may be set to 0, and TTT may be set to 256 ms. Describing the case of applying the above values by substituting them in the case of FIG. 5, the terminal may trigger a measurement report at a time point similar to the reference numeral 512. In this case, the measurement report message may include a signal strength measurement result for the second neighbor cell. Depending on configuration, the measurement report message may further include a signal strength measurement result for the first neighbor cell.

The source base station that receives the measurement report message may determine the second neighbor cell, rather than the first neighbor cell, as a handover target cell according to the handover decision algorithm. Since the second neighbor cell is determined as a handover target cell for the terminal, the terminal may not transmit an additional measurement report message, and no additional handover occurs.

In this case, as described in the above exemplary embodiments, the measurement report message may include reception signal strength measurement results for other neighbor cell(s) at a time point when the measurement report is triggered and at a time point before that. As described above, the measurement report message may include a signal strength prediction result for a specific cell, rather than a reception signal strength measurement result for the specific cell, based on configuration information from the base station.

As another example, the measurement report message may include reception signal strength measurement results for other neighbor cell(s) at the time when the measurement report is triggered and at a time point after that. As described above, the measurement report message may include a signal strength prediction result for a specific cell, rather than a reception signal strength measurement result for the specific cell, based on configuration information from the base station.

For each case of the above-described cases, the base station (or serving cell) may determine a more accurate handover target based on information on signal strengths included in the measurement report.

### (6) Terminal Measurement Reporting Method to Reduce Measurement Reporting Frequency

In the situation described in FIG. 5, the terminal needs to transmit a measurement report within a short time period. Therefore, according to the present disclosure, in order to prevent frequent measurement report transmissions and reduce unnecessary handovers, even when an event triggering a measurement report occurs, a measurement report may be configured not to be transmitted when a signal strength measurement result or prediction result satisfies a preconfigured condition.

As a method using signal strength measurement results of the terminal, the base station may configure the terminal not to transmit a measurement report when a neighbor cell (e.g. first neighbor cell) in which an event triggering the measurement report occurred is not the best neighbor cell (e.g. second neighbor cell).

When the neighbor cell in which the event triggering the measurement report occurs is not the best neighbor cell, the base station may configure the terminal not to transmit a measurement report if a time longer than a preset time among a time configured as a TTT for the same event of the second neighbor cell elapses. For example, when the TTT is set to 256 ms for the same event of the second neighbor cell and the preset time is 128 ms, the base station may configure the terminal not to transmit a measurement report message if the same event as in the second neighbor cell occurs at a time point when 128 ms or more elapses.

As a method using signal strength prediction results of the terminal, the base station may configure the terminal not to transmit a measurement report when a neighbor cell (e.g. first neighbor cell) in which an event triggering the measurement report occurs is not the best neighbor cell (e.g. second neighbor cell) at a specific time point according to the signal strength prediction results. As another method, the base station may configure, through an RRC reconfiguration message, the terminal not to transmit a measurement report when a neighbor cell (e.g. first neighbor cell) in which an event triggering the measurement report occurs is predicted not to be the best neighbor cell at a specific time point according to the signal strength prediction results and the TTT for the same event of the second neighbor cell is predicted to be satisfied at the specific time point.

The base station may configure an RRC reconfiguration message such that the terminal does not transmit a measurement report when a specific condition is satisfied. A case where the base station transmits an RRC reconfiguration message including the specific condition to the terminal will be described with reference to FIG. 5.

When applying the above-described method of configuring not to transmit a measurement report, during a period after the time point indicated by the reference numeral 511, the terminal may trigger one measurement report, and the terminal may perform only one handover in the optimal case. When using the above-described method, a measurement report message may be transmitted at a time point when an A3 event occurs by comparing signal strengths of the cell D 504 (i.e. second neighbor cell) and the cell B 502 (i.e. serving cell), which is the same time point as the time point indicated by the reference numeral 513. At this time, the measurement report message transmitted from the terminal to the base station may include a signal strength measurement result for the cell C 503 (i.e. first neighbor cell) and a signal strength measurement result for the cell D 504 (i.e. second neighbor cell).

The source base station that receives the measurement report message may determine the second neighbor cell, rather than the first neighbor cell, as a handover target cell according to the handover decision algorithm. Based on the handover decision, the base station may transmit a HO CMD message to the terminal, and the terminal receiving the HO CMD message may perform a handover to the second neighbor cell. Accordingly, unlike the scheme exemplified above FIG. 5, additional measurement report does not need to be transmitted, and the terminal may not perform additional handovers.

In this case, as described in the above exemplary embodiments, the measurement report message may include reception signal strength measurement results for other neighbor cell(s) at a time point when the measurement report is triggered and at a time point before that. As described above, the measurement report message may include a signal strength prediction result for a specific cell, rather than a reception signal strength measurement result for the specific cell, based on configuration information from the base station.

As another example, the measurement report message may include reception signal strength measurement results for other neighbor cell(s) at the time when the measurement report is triggered and at a time point after that. As described above, the measurement report message may include a signal strength prediction result for a specific cell, rather than a reception signal strength measurement result for the specific cell, based on configuration information from the base station.

For each case of the above-described cases, the base station (or serving cell) may determine a more accurate handover target based on information on signal strengths included in the measurement report.

In order to instruct the terminal to perform the method for reducing a frequency of measurement reports according to the present disclosure, the base station may provide the terminal with information for configuring not to transmit a measurement report when a specific condition is satisfied. As a method for this, the base station may include the corresponding configuration information in a parameter reportConfigToAddModList, which provides a list of measurement reporting targets to be added or modified, within the measurement configuration IE (i.e. measConfig IE) included in the RRC reconfiguration message. The configuration information may include information on the specific condition described above. The terminal that receives the RRC reconfiguration message including the specific condition may determine whether a measurement report needs to be transmitted if the specific condition based on the RRC reconfiguration message is satisfied, even when a measurement report trigger event occurs. Accordingly, the terminal can transmit a measurement report message to the base station only when transmission of the measurement report message is required.

### (7) Adaptive TTT Application Method Based on Source Cell Radio Link State

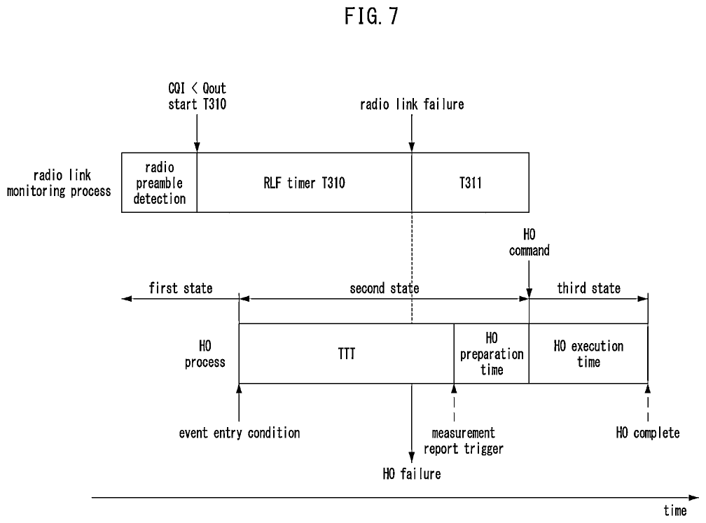

FIG. 7 is a conceptual diagram for describing a criterion for determining a handover failure in 3GPP handover performance simulation.

When an event entry condition of an event is satisfied, a handover process of the terminal may apply a preset TTT. If the event is maintained during the TTT, the terminal may trigger a measurement report and transmit a measurement report message to the base station. The base station may decide a handover and transmit a HO CMD message to the terminal. The terminal may receive the HO CMD message and execute the handover. Meanwhile, if a radio link with a source cell is poor and the terminal is in an out-of-sync state with the source cell, the terminal may start a T310 timer. If the T310 timer expires before receiving the HO CMD message, the terminal may declare a radio link failure (RLF) and a handover failure may occur.

The situation described above will be described again with reference to FIG. 7. In FIG. 7, a horizontal axis may represent time. A radio link monitoring process may be an operation that detects a radio preamble of the serving cell. If a CQI measured for the serving cell is less than a reference value set as Qout, the terminal may start the T310 timer.

In addition, the handover process is illustrated in a lower part of FIG. 7. A first state may be a state in which normal communication is performed with the serving cell. In other words, the first state may correspond to a state where conditions for handover are not satisfied. At this time, when a handover event entry condition (e.g. A3 event trigger condition) is satisfied, the terminal may identify whether a reception signal strength of the first cell has a higher value than a reception signal strength of the serving cell by an offset for the A3 event during a TTT. Event at this time point, the T310 timer in the radio link monitoring process may still be running. If the T310 timer expires before the TTT expires, a RLF may occur. In other words, the terminal may transition to an out-of-sync state with the serving cell. Then, the terminal may experience a handover failure during the handover process.

When the T310 timer expires in the radio link monitoring process, an RRC connection reestablishment procedure may be initiated. When the RRC connection reestablishment procedure is initiated, a T311 timer may start.

On the other hand, if a handover failure does not occur, a measurement report may be triggered after the TTT elapses, and the terminal may take a time to prepare for the handover. If a normal connection with the serving cell is maintained (i.e. if a CQI measured for a signal received from the serving cell is higher than Qout), the terminal may trigger transmission of a measurement report message. The terminal may receive a HO CMD message from the serving cell in response to transmission of the terminal's measurement report message. Upon receiving the HO CMD message, the terminal may transition from the second state to a third state for performing the handover. Therefore, the second state of the terminal may be determined as a period corresponding to a sum of the TTT and the handover preparation time. Thereafter, the terminal may be in the third state (i.e. state in which the handover to the target cell is executed). When the handover is completed, the target cell may become a serving cell, and the terminal may communicate with the serving cell.

In order to prevent the above-described handover failure, according to the present disclosure, the terminal may adaptively set and apply TTT according to the radio link state with the source cell. By applying the adaptive TTT according to the present disclosure, the terminal can reduce occurrences of handover failure by performing the handover procedure more quickly when the radio link condition with the source cell is poor.

In FIG. 7, when the T310 timer for RLF declaration is running, a TTT smaller than the preset TTT may be applied according to the present disclosure. For example, 0.25*TTT may be applied. In other words, a TTT which is a time smaller than ¼ of the actually set TTT may be applied. Accordingly, the measurement report is triggered before the T310 timer expires, and thus the terminal may transmit a measurement report message to the base station. In addition, the base station may transmit a HO CMD message to the terminal based on the measurement report message. The terminal may receive the HO CMD message from the base station before declaring RLF, and perform the handover to the target cell. Through this, the handover failure can be prevented according to the present disclosure. The value set above, that is, 0.25, is merely an example, and a different value may be set.

In addition, the base station may generate TTT scaling configuration information to adaptively apply TTT based on the radio link state with the source cell, and transmit the TTT scaling configuration information to the terminal. As a method of providing the TTT scaling configuration information to the terminal, the base station may use a parameter reportConfigToAddModList included in the measurement configuration IE (measConfig IE) in the RRC reconfiguration message. In other words, the RRC reconfigured message may be configured by including the TTT scaling configuration information in reportConfigToAddModList which is a list of measurement reporting targets to be added or modified.

The terminal that receives the RRC reconfiguration message may identify the TTT scaling configuration information in the parameter reportConfigToAddModList, and apply TTT adaptively according to the radio link state with the source cell based on the TTT scaling configuration information.

In an exemplary embodiment, the adaptive TTT value may be set a TTT value to be applied to a specific radio link state. The 3GPP technical specification may include a list of configurable TTT values as shown in Table 10 below.

TABLE 10
-- ASN1START
-- TAG-TIMETOTRIGGER-START

| | |
|---|---|
| Time To Trigger ::= | ENUMERATED { |
| | ms0, ms40, ms64, ms80, ms100, ms128, ms160, ms256, |
| | ms320, ms480, ms512, ms640, ms1024, ms1280, ms2560, |
| | ms5120} |

-- TAG-TIMETOTRIGGER-STOP
-- ASN1STOP

For example, the base station may configure ms1280 to be applied as a TTT value when the T310 timer is not running, and may configure ms128 to be applied as a TTT value when the T310 timer is running. The base station may further classify the radio link state with the source cell, and configure a TTT value to be applied to a specific radio link state. For example, sections of SINR, wideband CQI, RSRQ, RSSI, RSRP, etc. may be configured, and a TTT value to be applied to each section thereof may be defined. As a specific example, in case that a SINR is −6 dB or more, ms1280 may be configured to be applied as a TTT value, in case that −8 dB<SINR<−6 dB, ms512 may be configured to be applied as a TTT value, and in case that SINR is −8 dB or less, ms128 may be configured to be applied as a TTT value.

As another method, the base station may set a TTT scaling value to be applied to a specific radio link state. For example, when the T310 timer is not running, ms1280 may be configured to be applied as a TTT value, and when the T310 timer is running, a scaling value of 0.1 may be configured to be applied so that ms1280*0.1 is applied as a TTT value. The base station may further classify the radio link state with source cell, and configure a TTT scaling value to be applied to a specific radio link state. For example, sections of SINR, wideband CQI, RSRQ, RSSI, RSRP, etc. may be configured, and a TTT scaling value to be applied to each section thereof may be defined. As a specific example, in case that a SINR is −6 dB or more, ms1280 may be configured to be applied as a TTT value, in case that −8 dB<SINR<−6 dB, ms1280*0.5 may be configured to be applied as a TTT value by applying a scaling value of 0.5, and in case that SINR is −8 dB or less, ms1280*0.1 may be configured to be applied as a TTT value by applying a scaling value of 0.1.

Meanwhile, the terminal, base station, or serving cell described above may have the configuration of the communication node described in FIG. 2. When the communication node is the terminal, the above-described operations of the terminal may be performed by the processor 210 of the communication node. In other words, when the communication node is the terminal, the processor 210 may control triggering of a measurement report message, generation of the measurement report message, and transmission of the measurement report message to the base station.

On the other hand, when the communication node is the base station, serving cell, or target cell, operations such as generating an RRC reconfiguration message, transmitting the RRC reconfiguration message, determining a handover, and transmitting a HO command message may be performed by the processor 210.

In addition, the prediction operations according to the present disclosure may be performed by the processor 210. The prediction operations may be performed through an artificial intelligence (AI) and/or machine learning (ML) device or algorithm using preconfigured deep neural networks (DNNs).

In addition, when the communication node is the terminal, the transceiver 230 may measure signal strengths of the serving cell and neighbor cells and provide the signal strengths to the processor 210. In addition, when the communication node is the terminal, the transceiver 230 may perform an operation of transmitting the measurement report message to the serving cell over the air (wireless section) under the control of the processor 210. In addition, the transceiver 230 may receive the RRC reconfiguration message, HO command message, etc. received from the serving cell under the control of the processor 210, and provide them to the processor 210.

In addition, when the communication node is the base station, the transceiver 230 may provide signals received from the terminal to the processor 210. In addition, when the communication node is the base station, the transceiver 230 may perform an operation of transmitting various signals and/or messages to be transmitted to the terminal wirelessly (radio section) under the control of the processor 210.

Meanwhile, the respective exemplary embodiments have been described one by one. However, two or more of the exemplary embodiments (1) to (7) described above may be used in combination. For example, the additional information described in the exemplary embodiment (2) may be applied in addition to the additional information described in the exemplary embodiment (1). Further, the exemplary embodiments (1) and/or (2) may be applied in further combination with any one of the exemplary embodiments (4) to (7).

Although these modified examples have been described only for the exemplary embodiments (1) and (2), the exemplary embodiment (3) may also be equally and/or additionally applied. The present disclosure does not illustrate all of these combinations, but those skilled in the art may selectively combine and use the exemplary embodiments described in the present disclosure based on the content described above.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a serving cell, a first message including measurement report configuration information;
in response to transmission of a measurement report message being triggered based on the first message, generating a measurement report message; and
in response to a measurement report message transmission condition configured by the first message being satisfied, transmitting the measurement report message to the serving cell,
wherein the measurement report message includes first cell information about a first cell triggering transmission of the measurement report message at a time point when transmission of the measurement report message is triggered, and second cell information about a second cell having a highest signal strength at the time point when transmission of the measurement report message is triggered.

2. The method according to claim 1, wherein the measurement report message further includes signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

3. The method according to claim 1, wherein the measurement report message further includes signal strength prediction information for the first cell at a predetermined specific time point after transmission of the measurement report message is triggered, and information on a fourth cell predicted to have a highest signal strength at the predetermined specific time point after transmission of the measurement report message is triggered.

4. The method according to claim 1,
wherein the measurement report message transmission condition corresponds to a case where a reception signal strength of the first cell is maintained higher than a reception signal strength of the serving cell during a time-to-trigger (TTT) indicated by the first message,
wherein signal strength measurement information received from the first cell includes first measurement information for a signal received from the first cell at a time point when a trigger entry condition for transmission of the measurement report message is satisfied and second measurement information for a signal received from the first cell at a time point when the TTT elapses, and
wherein signal strength measurement information received from the second cell includes third measurement information for a signal received from the second cell at the time point when the trigger entry condition for transmission of the measurement report message is satisfied, and fourth measurement information for a signal received from the second cell at a time point when the TTT elapses.

5. The method according to claim 4, wherein the measurement report message further includes fifth measurement information for a signal received from the serving cell at a time point when a trigger entry condition for transmission of the measurement report message is satisfied, and sixth measurement information for a signal received from the serving cell at a time point when a condition of the TTT condition is satisfied.

6. The method according to claim 1, wherein the measurement report message further includes information about a third cell having a highest signal strength among cells having higher signal strengths than the serving cell before transmission of the measurement report message is triggered, and information on a time point when the third cell becomes a cell having the highest signal strength.

7. The method according to claim 6, wherein the measurement report message further includes signal strength measurement information for the serving cell at the time point when the third cell becomes the cell with the highest signal strength.

8. The method according to claim 1, wherein the first message further includes a scaling value for adjusting a TTT based on a signal strength of the serving cell.

9. A method of a base station, comprising:
transmitting, to a terminal, a first message including measurement report configuration information;
receiving, from the terminal, a measurement report message based on the first message;
determining a target cell to which the terminal is to be handed over based on the measurement report message;
transmitting a request for a handover of the terminal to the target cell; and
in response to receiving, from the target cell, a response to the request for the handover of the terminal, transmitting a handover command to the terminal,
wherein the measurement report configuration information includes a condition for triggering the measurement report message and configuration information of the measurement report message to be transmitted by the terminal, and the measurement report message received from the terminal includes first cell information about a first cell triggering transmission of the measurement report message at a time point when transmission of the measurement report message is triggered, and second cell information about a second cell having a highest signal strength at the time point when transmission of the measurement report message is triggered.

10. The method according to claim 9, wherein the measurement report message further includes signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

11. The method according to claim 9, wherein the measurement report message further includes signal strength prediction information for the first cell at a predetermined specific time point after transmission of the measurement report message is triggered, and information on a fourth cell predicted to have a highest signal strength at the predetermined specific time point after transmission of the measurement report message is triggered.

12. The method according to claim 9, wherein the measurement report message further includes information about a third cell having a highest signal strength among cells having higher signal strengths than the serving cell before transmission of the measurement report message is triggered, and information on a time point when the third cell becomes a cell having the highest signal strength.

13. The method according to claim 12, wherein the measurement report message further includes signal strength measurement information for the serving cell at the time point when the third cell becomes the cell with the highest signal strength.

14. The method according to claim 9, wherein the first message further includes a scaling value for adjusting a TTT based on a signal strength of the serving cell.

15. A terminal comprising a processor, wherein the processor causes the terminal to perform:
receiving, from a serving cell, a first message including measurement report configuration information;
in response to transmission of a measurement report message being triggered based on the first message, generating a measurement report message; and
in response to a measurement report message transmission condition configured by the first message being satisfied, transmitting the measurement report message to the serving cell,
wherein the measurement report message includes first cell information about a first cell triggering transmission of the measurement report message at a time point when transmission of the measurement report message is triggered, and second cell information about a second cell having a highest signal strength at the time point when transmission of the measurement report message is triggered.

16. The terminal according to claim 15, wherein the measurement report message further includes signal strength measurement information for the first cell at an earliest predetermined measurement time point among time points before transmission of the measurement report message is triggered, and information on a third cell having a highest signal strength at the predetermined measurement time point among the time points before transmission of the measurement report message is triggered.

17. The terminal according to claim 15, wherein the measurement report message further includes signal strength prediction information for the first cell at a predetermined specific time point after transmission of the measurement report message is triggered, and information on a fourth cell predicted to have a highest signal strength at the predetermined specific time point after transmission of the measurement report message is triggered.

18. The terminal according to claim 15,
wherein the measurement report message transmission condition corresponds to a case where a reception signal strength of the first cell is maintained higher than a reception signal strength of the serving cell during a time-to-trigger (TTT) indicated by the first message,
wherein signal strength measurement information received from the first cell includes first measurement information for a signal received from the first cell at a time point when a trigger entry condition for transmission of the measurement report message is satisfied and second measurement information for a signal received from the first cell at a time point when the TTT elapses, and
wherein signal strength measurement information received from the second cell includes third measurement information for a signal received from the second cell at the time point when the trigger entry condition for transmission of the measurement report message is satisfied, and fourth measurement information for a signal received from the second cell at a time point when the TTT elapses.

19. The terminal according to claim 15, wherein the measurement report message further includes information about a third cell having a highest signal strength among cells having higher signal strengths than the serving cell before transmission of the measurement report message is triggered, and information on a time point when the third cell becomes a cell having the highest signal strength.

20. The terminal according to claim 19, wherein the measurement report message further includes signal strength measurement information for the serving cell at the time point when the third cell becomes the cell with the highest signal strength.
